(19) United States
(12) Patent Application Publication
(10) Pub. No.: US 2018/0039950 A1
(43) Pub. Date: Feb. 8, 2018

(54) AUTOMATED APPOINTMENT SCHEDULING FROM SEARCH ENGINE QUERIES

(71) Applicant: Microsoft Technology Licensing, LLC, Redmond, WA (US)

(72) Inventors: Anshul Sud Kashyap, Redmond, WA (US); Abhinav Kashyap, Redmond, WA (US)

(21) Appl. No.: 15/227,077

(22) Filed: Aug. 3, 2016

(51) Int. Cl. G06Q 10/10; G06Q 30/06

(52) U.S. Cl. CPC G06Q 10/1095; G06Q 30/0625

(57) ABSTRACT

Appointments are scheduled for a user. A query that is submitted by the user is received, where this query includes data specifying a particular service the user is interested in. A computer network is then searched for information related to the data in the query. The query and the information found in this search are then analyzed to select a service provider that optimally matches the data in the query. An appointment for the particular service the user is interested in is then scheduled with the selected service provider.

### BACKGROUND

The Internet is a global data communications system that serves billions of people across the globe and provides them access to a vast array of online information resources and services including those provided by the World Wide Web and intranet-based enterprises. Search engines generally provide people with the ability to easily search for desired online information on a specific computing device or on a data communication network such as the Internet or a private network. Thanks to the ubiquity of the Internet and the wide variety of network-enabled end-user computing devices that exist today, people today spend a large and ever-increasing amount of time performing a variety of tasks online (e.g., over a data communication network), where these tasks include submitting queries to search engines to locate particular online information they are interested in. Various search engines exist today which vie for popularity.

People today also often have a need to schedule appointments with various types of service providers. Many people and service providers today manage their calendars that keep track of these appointments using an electronic (e.g., computer-based and thus software-based) calendar application (also known as an online calendar). Various electronic calendar applications exist today which vie for popularity. Many of today's electronic calendar applications are web-based (e.g., they store people's and service provider's calendar data in the cloud) and can be synchronized with each other. Today's electronic calendar applications may also provide a variety of other features such as allowing a given person's calendar to be synchronized across each of the network-enabled end-user computing devices that they use, and to be shared with other people.

### SUMMARY

Appointment scheduling technique implementations described herein are generally applicable to scheduling appointments for a user. In one exemplary implementation a query that is submitted by the user is received, where this query includes data specifying a particular service the user is interested in. A computer network is then searched for information related to the data in the query. The query and the information found in this search are then analyzed to select a service provider that optimally matches the data in the query. An appointment for the particular service the user is interested in is then scheduled with the selected service provider.

It should be noted that the foregoing Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. Its sole purpose is to present some concepts of the claimed subject matter in a simplified form as a prelude to the more-detailed description that is presented below.

### DESCRIPTION OF THE DRAWINGS

The specific features, aspects, and advantages of the appointment scheduling technique implementations described herein will become better understood with regard to the following description, appended claims, and accompanying drawings where:

FIG. 1 is a diagram illustrating one implementation, in simplified form, of a system framework for realizing the appointment scheduling technique implementations described herein.

FIG. 2 is a diagram illustrating another implementation, in simplified form, of a system framework for realizing the appointment scheduling technique implementations described herein.

FIG. 3 is a flow diagram illustrating one implementation, in simplified form, of a process for scheduling an appointment from a query submitted by a user, where the query includes data specifying a particular service the user is interested in.

FIG. 4 is a flow diagram illustrating one implementation, in simplified form, of a process for analyzing the query and search results for the query to select a service provider that optimally matches the data in the query.

FIG. 5 is a flow diagram illustrating another implementation, in simplified form, of a process for analyzing the query and the search results for the query to select a service provider that optimally matches the data in the query.

FIG. 6 is a flow diagram illustrating one implementation, in simplified form, of a process for scheduling an appointment for the particular service the user is interested in with the selected service provider.

FIG. 7 is a flow diagram illustrating an exemplary implementation, in simplified form, of a process for collectively analyzing identified calendars for the user and identified calendars for the selected service provider to determine a soonest open time-slot that is currently available for the appointment in each of the identified calendars for the user, and is also currently available for the appointment in each of the identified calendars for the selected service provider.

FIG. 8 is a flow diagram illustrating another implementation, in simplified form, of a process for scheduling an appointment for the particular service the user is interested in with the selected service provider.

FIG. 9 is a flow diagram illustrating another implementation, in simplified form, of a process for scheduling an appointment from a query submitted by a user, where the query includes data specifying a particular service the user is interested in.

FIG. 10 is a diagram illustrating one implementation, in simplified form, of an appointment scheduler computer program for scheduling appointments.

FIG. 11 is a diagram illustrating another implementation, in simplified form, of an appointment scheduler computer program for scheduling appointments.

FIG. 12 is a diagram illustrating a simplified example of a general-purpose computer system on which various implementations and elements of the appointment scheduling technique, as described herein, may be realized.

### DETAILED DESCRIPTION

In the following description of appointment scheduling technique implementations reference is made to the accompanying drawings which form a part hereof, and in which are shown, by way of illustration, specific implementations in which the appointment scheduling technique can be practiced. It is understood that other implementations can be utilized and structural changes can be made without departing from the scope of the appointment scheduling technique implementations.

It is also noted that for the sake of clarity specific terminology will be resorted to in describing the appointment scheduling technique implementations described herein and it is not intended for these implementations to be limited to the specific terms so chosen. Furthermore, it is to be understood that each specific term includes all its technical equivalents that operate in a broadly similar manner to achieve a similar purpose. Reference herein to “one implementation”, or “another implementation”, or an “exemplary implementation”, or an “alternate implementation”, or “one version”, or “another version”, or an “exemplary version”, or an “alternate version”, or “one variant”, or “another variant”, or an “exemplary variant”, or an “alternate variant” means that a particular feature, a particular structure, or particular characteristics described in connection with the implementation or version can be included in at least one implementation of the appointment scheduling technique. The appearances of the phrases “in one implementation”, “in another implementation”, “in an exemplary implementation”, “in an alternate implementation”, “in one version”, “in another version”, “in an exemplary version”, “in an alternate version”, “in one variant”, “in another variant”, “in an exemplary variant”, and “in an alternate variant” in various places in the specification are not necessarily all referring to the same implementation or version, nor are separate or alternative implementations/versions mutually exclusive of other implementations/versions. Yet furthermore, the order of process flow representing one or more implementations or versions of the appointment scheduling technique does not inherently indicate any particular order nor imply any limitations of the appointment scheduling technique.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive, in a manner similar to the term “comprising”, as an open transition word without precluding any additional or other elements.

1.0 Automated Appointment Scheduling from Search Engine Queries

The appointment scheduling technique implementations described herein generally involve the automated scheduling of appointments for services that users are interested in based on search engine queries that are submitted by the users. The term “user” is used herein to refer to a person who utilizes a network-enabled end-user computing device and desires to schedule an appointment for a particular service. Accordingly, a given user may become a customer of a given service provider who provides the particular service the user is interested in (e.g., the user may become a receiver of the particular service). Exemplary types of network-enabled end-user computing devices are described in more detail hereafter. The term “service provider” is used herein to refer to an entity (e.g., an individual, or an enterprise, or an organization, or the like) that provides one or more services that are associated with one or more industries, and offers users the ability to schedule appointments for these services. Exemplary types of service providers and the industries with which they are associated are also described in more detail hereafter.

The appointment scheduling technique implementations described herein are advantageous for various reasons including, but not limited to, the following. As will be appreciated from the foregoing and the more-detailed description that follows, the appointment scheduling technique implementations greatly increase user efficiency, and also greatly increase service provider efficiency and profitability. For example, since the appointment scheduling technique implementations automate the process of scheduling appointments for services that users are interested in, the appointment scheduling technique implementations minimize the time and effort users have to expend to schedule these appointments with the service providers who provide (e.g., perform/deliver) these services. The appointment scheduling technique implementations also minimize the time and personnel resources service providers have to expend to schedule appointments with users (e.g., the appointment scheduling technique implementations eliminate the need for service providers to dedicate employees to administering/managing the appointment scheduling process). Additionally, a given user can utilize the appointment scheduling technique implementations to schedule an appointment for a particular service that is provided by a particular service provider at any time of the day or night (e.g., at any time that is convenient for the user) without the user having to manually make a telephone call to the service provider and wait until a person who represents the service provider, and is responsible for manually scheduling appointments with the service provider, is available to answer the call. The appointment scheduling technique implementations also allow service providers to maximize the utilization of available time-slots in their calendar, thus maximizing the number of users they serve and the revenue they earn in a given period of time. Since the appointment scheduling technique implementations automatically enter (e.g., log) the scheduled appointments in both the users' and service providers' calendars, the appointment scheduling technique implementations eliminate the errors and inefficiencies associated with having to manually enter or forgetting to enter the scheduled appointments into each affected calendar.

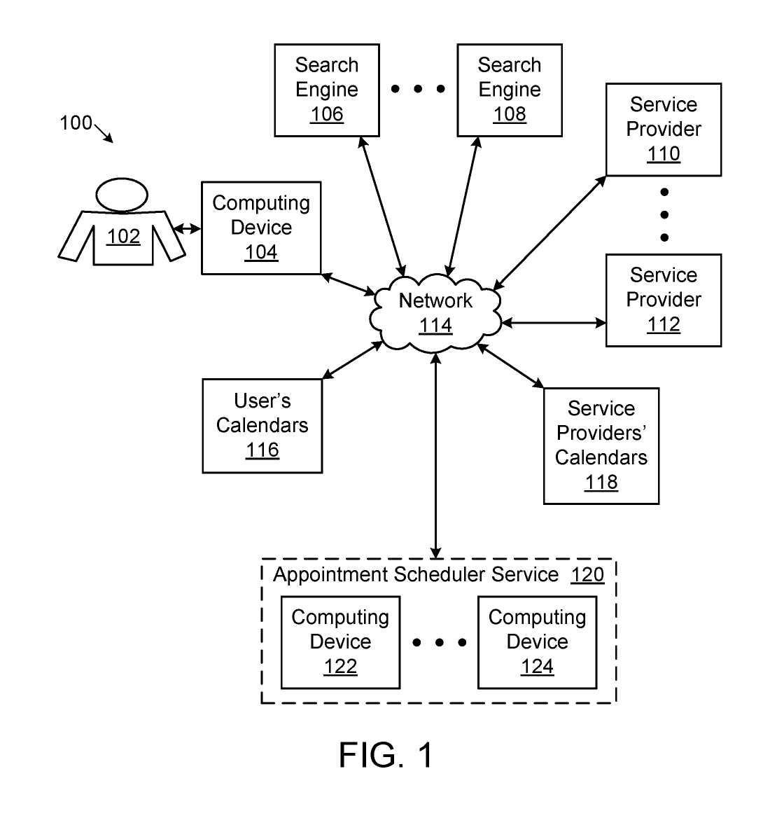

FIG. 1 illustrates one implementation, in simplified form, of a system framework for realizing the appointment scheduling technique implementations described herein. As exemplified in FIG. 1, the system framework 100 includes an end-user computing device 104 that is utilized by a user 102. The end-user computing device 104 can be any type of conventional mobile computing device such as a smartphone, or a tablet computer, or a laptop computer (sometimes also referred to as a notebook or netbook computer), or a computing device that is integrated into an automobile, among other types of conventional mobile computing devices. The end-user computing device 104 can also be any type of conventional non-mobile computing device such as a desktop personal computer (PC), or a video game console, among other types of conventional non-mobile computing devices.

Referring again to FIG. 1, the end-user computing device 104 is configured to communicate over a conventional data communication network 114 (herein also referred to as a computer network) such as the Internet (among other types of conventional data communication networks) with one or more search engines 106/108 and one or more service providers 110/112 that offer a particular service the user 102 is currently interested in (e.g., wants to schedule an appointment for). The particular service the user is currently interested in is hereafter sometimes simply referred to as the service of interest. The appointment scheduling technique implementations described herein are operable with any conventional web search engine such as GOOGLE™ (a trademark of Google, Inc.) Search (available at https://www.google.com/), YAHOO!® (a registered trademark of Yahoo! Inc.) Search (available at http://search.yahoo.com/), DUCK DUCK GO® (a registered service mark of DuckDuckGo, Inc.—available at https://duckduckgo.com/), and BING® (a registered trademark of Microsoft Corporation—available at https://www.bing.com/), among others. The appointment scheduling technique implementations are also operable with any type of service provider whose services are associated with any type of industry. By way of example but not limitation, the appointment scheduling technique implementations are operable with doctors, dentists, chiropractors, urgent care facilities, hospitals, and the like that are associated with the healthcare industry. The appointment scheduling technique implementations are also operable with barber shops, hair salons, nail salons, estheticians, spas, and the like that are associated with the beauty industry. The appointment scheduling technique implementations are also operable with electricians, plumbers, carpenters, handymen, pest control service providers, and the like that are associated with the home maintenance industry. The appointment scheduling technique implementations are also operable with accountants, financial planners, stock brokers, financial institutions, and the like that are associated with the financial industry.

Referring again to FIG. 1, the system framework 100 also includes one or more calendars 116 for (e.g., belonging to) the user 102, where these calendars 116 provide information about the current availability of the user 102 for future appointments. Each of the user's calendars 116 is an electronic (e.g., online) calendar that is accessible via the data communication network 114 and may be located either on the end-user computing device 104 or in the cloud. In the case where there is a plurality of different calendars 116 for the user 102, each of these different calendars 116 may be associated with a different context of the user's life (e.g., the user may have one or more personal calendars, and one or more work calendars, among other types of calendars). The system framework 100 also includes one or more calendars 118 for each of the service providers 110/112, where these calendars 118 provide information about the current availability of each of the service providers 110/112 to provide each of the services that is offered by the service provider (e.g., in the case where a given service provider employs a plurality of people who perform the services offered by the service provider, the service provider may have a different calendar for each of these people). Each of the service providers' calendars 118 is also an electronic calendar that is accessible via the network 114. In an exemplary implementation of the appointment scheduling technique described herein each of the service providers' calendars 118 is located in the cloud. The calendars 116 for the user 102 and the calendars 118 for each of the service providers 110/112 are generally managed by one or more conventional electronic calendar applications (not shown) which may include one or more conventional personal information management applications that support electronic calendars. As described heretofore, various electronic calendar applications exist today which vie for popularity. Many of today's electronic calendar applications support a conventional open protocol that can be used to access the user's calendars 116 and the service providers' calendars 118 via the network 114.

Referring again to FIG. 1, the end-user computing device 104 is utilized by the user 102 to perform a wide variety of tasks. By way of example but not limitation and as will be described in more detail hereafter, the user 102 may utilize the end-user computing device 104 to submit a query to a desired one of the search engines 106/108, where this query may include data specifying the aforementioned particular service the user is currently interested in. The user 102 may also utilize the end-user computing device 104 to view and manage their calendars 116, and to schedule an appointment for this particular service.

Referring again to FIG. 1, the end-user computing device 104, the search engines 106/108, the service providers 110/112, the user's calendars 116, and the service providers' calendars 118 are also configured to communicate over the data communication network 114 with an appointment scheduler service 120 that runs on one or more other computing devices 122/124. These other computing devices 122/124 can also communicate with each other via the network 114. In an exemplary implementation of the appointment scheduling technique described herein the other computing devices 122/124 are located in the cloud so that the scheduler service 120 operates as a cloud service and the network 114 includes wide area network functionality. The term “cloud service” is used herein to refer to a web application that operates in the cloud and can be hosted on (e.g., deployed at) a plurality of data centers that can be located in different geographic regions (e.g., different regions of the world).

Referring again to FIG. 1 and as will be described in more detail hereafter, the appointment scheduler service 120 generally performs a variety of functions associated with scheduling appointments for services that the user 102 is interested in. By way of example but not limitation, in an exemplary implementation of the appointment scheduling technique described herein the scheduler service 120 receives a query that is submitted by the user 102, where the query includes data specifying a particular service the user is interested in. The scheduler service 120 then forwards the query to one of the search engines 106/108. The scheduler service 120 then receives search results for the query from the one of the search engines 106/108, and analyzes the query and the search results to select a one of the service providers 110/112 that optimally matches the data in the query. The scheduler service 120 then schedules an appointment for the service of interest with the selected one of the service providers 110/112.

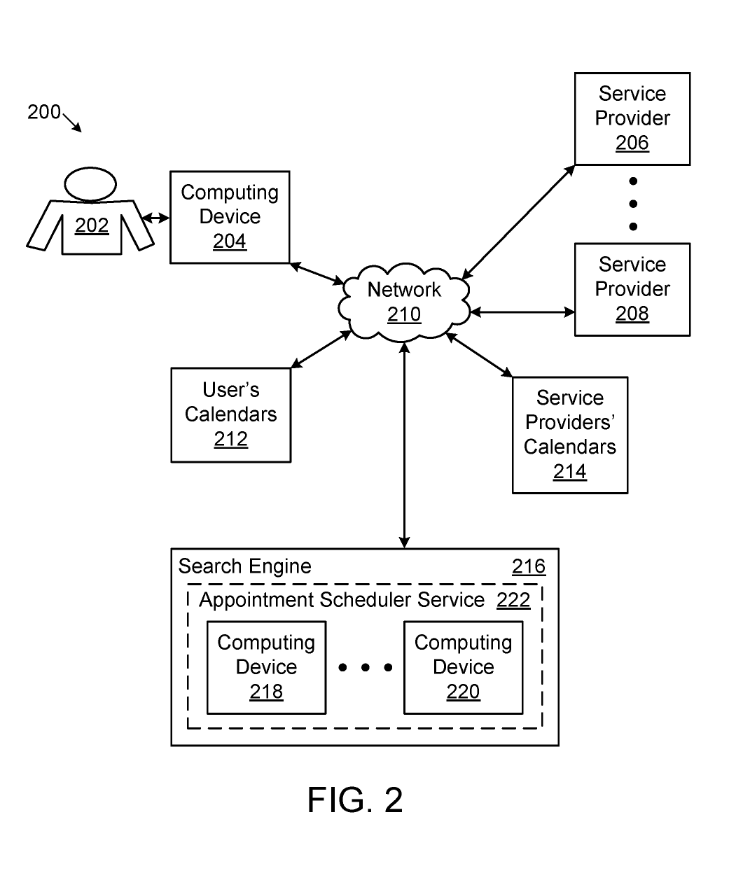

FIG. 2 illustrates another implementation, in simplified form, of a system framework for realizing the appointment scheduling technique implementations described herein. As exemplified in FIG. 2, the system framework 200 includes the aforementioned end-user computing device 204 that is utilized by a user 202. The end-user computing device 204 is configured to communicate over the aforementioned data communication network 210 with the aforementioned one or more service providers 206/208 that offer a particular service the user 202 is currently interested in. The system framework 200 also includes the aforementioned one or more calendars 212 for the user 202 that are accessible via the network 210, and the aforementioned one or more calendars 214 for each of the service providers 206/208 that are also accessible via the network 210. The end-user computing device 204, the service providers 206/208, the user's calendars 212, and the service providers' calendars 214 are also configured to communicate over the data communication network 114 with a search engine 216 that is customized to include an integrated appointment scheduler service 222 that runs on one or more other computing devices 218/220. These other computing devices 218/220 can also communicate with each other via the network 210. In an exemplary implementation of the appointment scheduling technique described herein the other computing devices 218/220 are located in the cloud so that the scheduler service 222 operates as a cloud service.

Referring again to FIG. 2 and as will be described in more detail hereafter; the integrated appointment scheduler service 222 generally performs a variety of functions associated with scheduling appointments for services that the user 202 is interested in. By way of example but not limitation, in an exemplary implementation of the appointment scheduling technique described herein the scheduler service 222 receives a query that is submitted by the user 202, where the query includes data specifying a particular service the user is interested in. The scheduler service 222 then uses the resources of the search engine 216 to search the data communication network 210 for information related to the data in the query. The scheduler service 222 then analyzes the query and the information found in the search (herein also referred to as the search results) to select a one of the service providers 206/208 that optimally matches the data in the query. The scheduler service 222 then schedules an appointment for the service of interest with the selected one of the service providers 206/208.

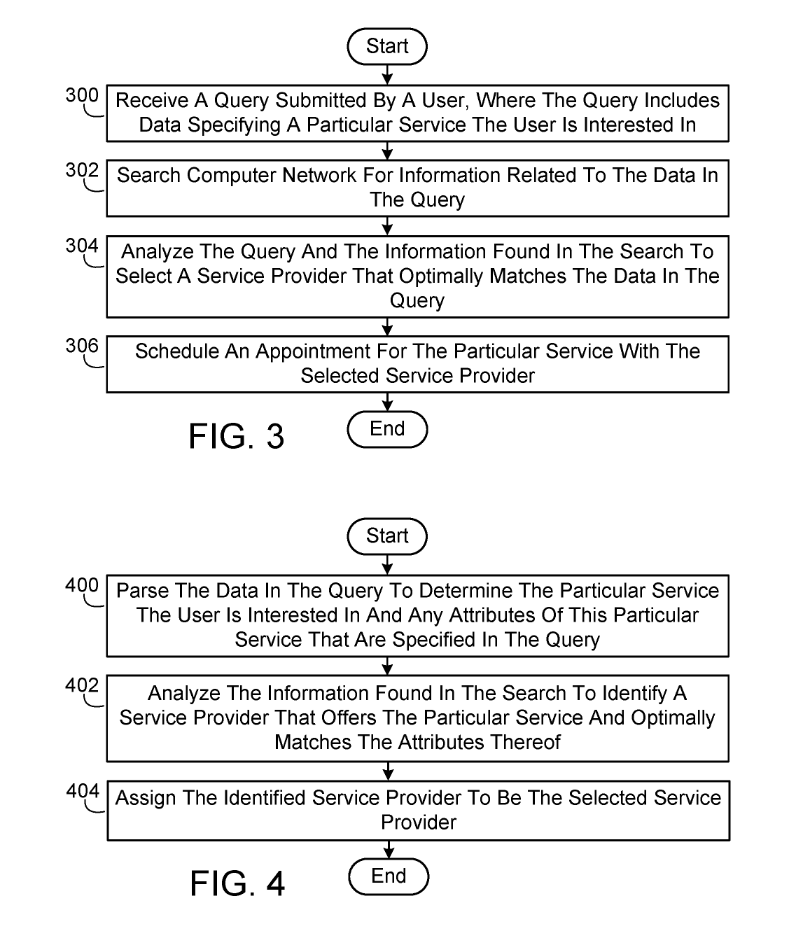

FIG. 3 illustrates one implementation, in simplified form, of a process for scheduling appointments. In an exemplary implementation of the appointment scheduling technique described herein the process illustrated in FIG. 3 is realized on the system framework 200 illustrated in FIG. 2. As exemplified in FIG. 3, the process starts with receiving a query that is submitted by a user, where the query includes data specifying a particular service the user is interested in (process action 300). It will be appreciated that besides specifying the type of service the user is interested in, the data that the user enters into the query may specify one or more of a wide variety of attributes of this service. Generally speaking, the more data the user enters into the query the more specific the query search results will be. Exemplary types of queries that may be submitted by the user are described in more detail hereafter. After the user's query has been received (action 300), the computer network is searched for information related to the data in the query (process action 302). The query and the information found in the search are then analyzed to select a service provider that optimally matches the data in the query (process action 304)—exemplary methods for performing this analysis are described in more detail hereafter. An appointment for the service of interest is then scheduled with the selected service provider (process action 306).

FIG. 4 illustrates one implementation, in simplified form, of a process for analyzing the query and the information found in the search to select a service provider that optimally matches the data in the query. In other words, FIG. 4 illustrates one implementation of the action 304 that is shown in FIG. 3. As exemplified in FIG. 4, the process starts with parsing the data in the query to determine the particular service the user is interested in and any attributes of (e.g., criteria for) this particular service that are specified in the query (process action 400)—it will be appreciated this parsing can be performed using a variety of conventional intelligent query parsing methods. It will also be appreciated that the user may specify a wide variety of attributes and combinations thereof for the particular service they are interested in. Examples of such attributes include a desired location (e.g., a city, or a zip code, or the like) for the service provider who offers the service, a desired gender (e.g., male or female) for this service provider, and a desired rating for this service provider, among many other types of service provider attributes. After the parsing of action 400 has been completed, the information found in the search of action 302 is analyzed to identify a service provider that offers the service of interest and optimally matches the attributes thereof that are specified in the query (process action 402). The identified service provider is then assigned to be the selected service provider (process action 404).

As is appreciated in the art of search engines and the search results that are returned thereby, and referring again to FIGS. 3 and 4, the information found in the search of action 302 will often include rating information for one or more service providers that offer the particular service the user is interested in. More particularly, rating information for many different service providers is available from a various conventional online sources such as social media platforms, forums, websites, and the like (e.g., www.yelp.com, www.angieslist.com, www.amazon.com, and www.bbb.org, to name a few). In fact, this rating information may include one or more ratings from the user themselves. In the case where the information found in the search of action 302 includes the just-described provider rating information, the analysis of action 402 may use this provider rating information as a factor in this analysis. In the case where provider rating information is available from a plurality of different sources, the analysis of action 402 may individually weight the rating from each of the sources and compute an average rating, where the user's ratings may be given a higher weight whenever they are available.

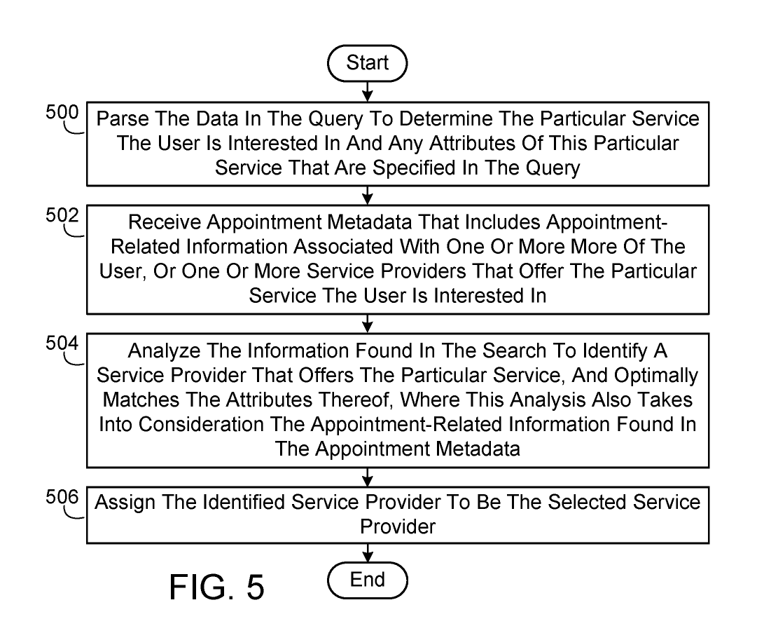

FIG. 5 illustrates another implementation, in simplified form, of a process for analyzing the query and the information found in the search to select a service provider that optimally matches the data in the query. In other words, FIG. 5 illustrates another implementation of the action 304 that is shown in FIG. 3. As exemplified in FIG. 5, the process starts with parsing the data in the query to determine the particular service the user is interested in and any attributes of this particular service that are specified in the query (process action 500). Appointment metadata is then received, where this metadata includes appointment-related information that is associated with one or more of the user, or one or more service providers that offer the service of interest (process action 502). Exemplary types of appointment metadata that may be received are described in more detail hereafter. The information found in the search of action 302 is then analyzed to identify a service provider that offers the service of interest and optimally matches the attributes thereof that are specified in the query, where this analysis also takes into consideration the appointment-related information that is found in the appointment metadata (process action 504). The identified service provider is then assigned to be the selected service provider (process action 506).

It will be appreciated that the appointment scheduling technique implementations described herein can receive many different types of appointment metadata from many different sources. By way of example but not limitation, the appointment metadata may include appointment preferences for the user which can be obtained from various sources such as previous appointments that were scheduled in the user's calendars, or a profile for the user that exists in a calendar application or personal information management application that is utilized by the user, among other sources. The appointment metadata may also include the last known geographic location of the user which can be obtained from various sources such as the GPS (global positioning system) functionality in a mobile computing device the user is carrying, or the user's calendars, among other sources. The appointment metadata may also include a physical address (e.g., a postal/street address) for a location where the user lives (e.g., the user's home address) which can be obtained from various sources such as the just-described profile for the user, among other sources. The appointment metadata may also include another physical address for another location where the user works (e.g., the user's work address) which can be obtained from various sources such as the profile for the user, among other sources. The appointment metadata may also include work hours for the service providers that offer the particular service the user is interested in which can be obtained from various sources such as the service providers' calendars, or profiles for the service providers that exist in a calendar application or personal information management application that is utilized by the service providers, or the service provider's websites, among other sources. The appointment metadata may also include any combination of the just-described different types of metadata.

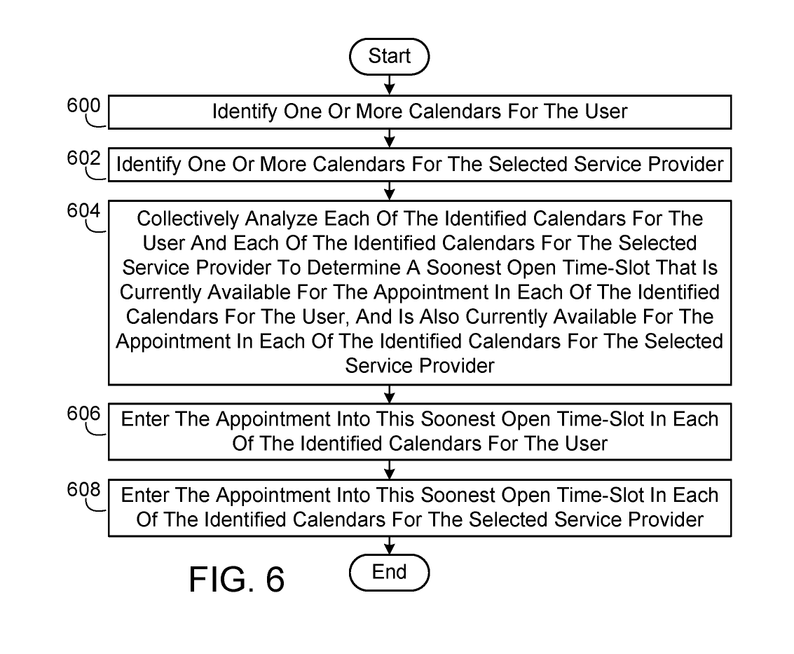

FIG. 6 illustrates one implementation, in simplified form, of a process for scheduling an appointment for the particular service the user is interested in with the selected service provider. In other words, FIG. 6 illustrates one implementation of the action 306 that is shown in FIG. 3. As exemplified in FIG. 6, the process starts with identifying one or more calendars for the user (process action 600), and identifying one or more calendars for the selected service provider (process action 602). It will be appreciated that the calendar identification of actions 600 and 602 can be performed in various ways. For example, in an exemplary implementation of the appointment scheduling technique described herein one or more calendars for the user are identified using the aforementioned profile for the user that exists in the calendar application or personal information management application that is utilized by the user. Similarly, one or more calendars for the selected service provider are identified using a profile for the selected service provider that exists in a calendar application or personal information management application that is utilized by the selected service provider.

Referring again to FIG. 6, after the calendars for the user and selected service provider have been identified (actions 600 and 602), each of the identified calendars for the user and each of the identified calendars for the selected service provider is collectively analyzed (e.g., synchronized/aggregated) to determine a soonest open (e.g., currently unscheduled) time-slot that is currently available for the appointment in each of the identified calendars for the user, and is also currently available for the appointment in each of the identified calendars for the selected service provider (process action 604). The appointment is then entered (e.g., logged) into this soonest open time-slot in each of the identified calendars for the user (process action 606), and also entered into this soonest open time-slot in each of the identified calendars for the selected service provider (process action 608). The soonest open time-slot that is currently available for the appointment in each of the identified calendars for the user, and is also currently available for the appointment in each of the identified calendars for the selected service provider, is hereafter sometimes simply referred to as the soonest co-available open time-slot. Given the foregoing, it will be appreciated that the process illustrated in FIG. 6 can result in an appointment for the particular service the user is interested in being scheduled automatically based on the user's query without requiring a confirmation from the user or the service provider.

It will be appreciated that the identified calendars for the user and the identified calendars for the selected service provider can be managed in various ways. For example, in one implementation of the appointment scheduling technique described herein the identified calendars for the user and the identified calendars for the selected service provider may be managed by a common calendar application that is accessible via the computer network. In another implementation of the appointment scheduling technique where the identified calendars for the user include a plurality of different calendars for the user, one or more of these different calendars for the user may be managed by one calendar application that is accessible via the computer network, and the others of these different calendars for the user may be managed by one or more other calendar applications that are also accessible via the computer network. In yet another implementation of the appointment scheduling technique where the identified calendars for the selected service provider include a plurality of different calendars for the selected service provider, one or more of these different calendars for the selected service provider may be managed by one calendar application that is accessible via the computer network, and the others of these different calendars for the selected service provider may be managed by one or more other calendar applications that are also accessible via the computer network.

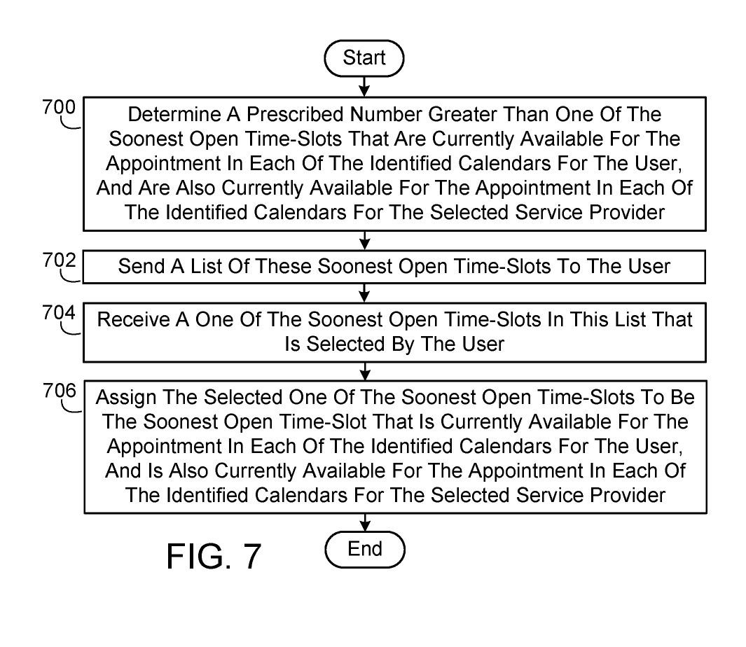

FIG. 7 illustrates an exemplary implementation, in simplified form, of a process for performing the just-described collective analysis of action 604 that is shown in FIG. 6. As exemplified in FIG. 7, the process starts with determining a prescribed number greater than one (e.g., two or three, among other numbers greater than one) of the soonest open time-slots that are currently available for the appointment in each of the identified calendars for the user, and are also currently available for the appointment in each of the identified calendars for the selected service provider (process action 700). A list of these soonest open time-slots is then sent to the user (process action 702), and the user may select a desired one of the soonest open time-slots in the list that they want to use to schedule the appointment. Upon the user selecting one of the soonest open time-slots in the list that was sent to them, the one of the soonest open time-slots that is selected by the user is received (process action 704), and the selected one of the soonest open time-slots is assigned to be the aforementioned soonest open time-slot that is currently available for the appointment in each of the identified calendars for the user, and is also currently available for the appointment in each of the identified calendars for the selected service provider (i.e., the soonest co-available open time-slot) (process action 706).

Referring again to FIG. 6, in an exemplary implementation of the appointment scheduling technique described herein the aforementioned action of entering the appointment into the soonest co-available open time-slot in each of the identified calendars for the user (action 606) includes the action of notifying the user that the appointment has been scheduled. It will be appreciated that this user notification can be performed in various ways such as via an email message that is sent to the user, or a text message that is sent to the user, or a phone call that is made to the user, among other ways. The user may specify a desired way of being notified in the aforementioned profile for the user. In an exemplary version of the just-described implementation the action of notifying the user that the appointment has been scheduled includes the action of sending the user a message specifying prescribed service provider details about the appointment that has been scheduled, where these service provider details include a date and time for which the appointment has been scheduled.

The just-described service provider details about the appointment that has been scheduled which are sent to user may also include various other types of information about this appointment. By way of example but not limitation, the service provider details may also include the name of the selected service provider. The service provider details may also include a physical address associated with the selected service provider—this is useful in the case where the user will be traveling to the selected service provider's location to receive the particular service they are interested in. The service provider details may also include a distance from this physical address to the expected geographic location of the user on the date for which, and a prescribed first short period of time (e.g., 60 minutes, among other short periods of time) before which, the appointment has been scheduled—this is also useful in the case where the user will be traveling to the selected service provider's location to receive the service of interest. This distance can be a physical distance that is measured in miles or kilometers (among other ways of measuring physical distance), or it can be an estimate of the travel time between the just-described expected geographic location of the user and the physical address associated with the selected service provider. In an exemplary implementation of the appointment scheduling technique described herein the just-described expected geographic location of the user is determined from the identified calendars for the user. The service provider details may also include contact information for the selected service provider (e.g., a phone number for the selected service provider, or an email address for the selected service provider, or a fax number for the selected service provider, among other types of contact information). The service provider details may also include a rating of the selected service provider that is generated by other users.

Referring again to FIG. 6, in an exemplary implementation of the appointment scheduling technique described herein the aforementioned action of entering the appointment into the soonest co-available open time-slot in each of the identified calendars for the selected service provider (action 608) includes the action of notifying the selected service provider that the appointment has been scheduled. It will be appreciated that this service provider notification can be performed in various ways such as via an email message that is sent to the selected service provider, or a text message that is sent to the selected service provider, or a phone call that is made to the selected service provider, among other ways. The selected service provider may specify a desired way of being notified in the aforementioned profile for the selected service provider. In an exemplary version of the just-described implementation the action of notifying the selected service provider that the appointment has been scheduled includes the action of sending the selected service provider a message specifying prescribed user details about the appointment that has been scheduled, where these user details include the date and time for which the appointment has been scheduled.

The just-described user details about the appointment that has been scheduled which are sent to the selected service provider may also include various other types of information about this appointment. By way of example but not limitation, the user details may also include the name of the user. The user details may also include a physical address associated with the expected geographic location of the user on the date and time for which the appointment has been scheduled—this is useful in the case where the selected service provider will be traveling to the user's location (e.g., the user's home) to provide the particular service the user is interested in. The user details may also include a distance from this physical address to the expected geographic location of the selected service provider on the date for which, and a prescribed second short period of time (which may be either the same as or different than the aforementioned first short period of time) before which, the appointment has been scheduled—this is also useful in the case where the selected service provider will be traveling to the user's location to provide the service of interest. This distance can be a physical distance, or it can be an estimate of the travel time between the just-described physical address of the user and the just-described expected geographic location of the selected service provider. In an exemplary implementation of the appointment scheduling technique described herein the just-described expected geographic location of the selected service provider is determined from the identified calendars for the selected service provider. The user details may also include contact information for the user (e.g., one or more phone numbers for the user (e.g., a home phone number for the user, or a mobile phone number for the user, or both), or an email address for the user, or a fax number for the user, among other types of contact information). The user may specify a desired way to be contacted in the aforementioned profile for the user.

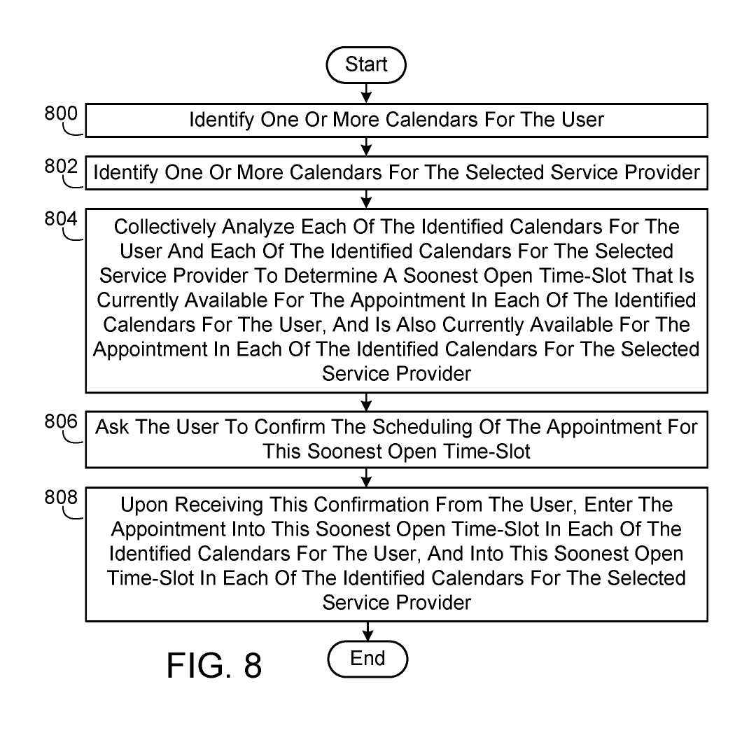

FIG. 8 illustrates another implementation, in simplified form, of a process for scheduling an appointment for the particular service the user is interested in with the selected service provider. In other words, FIG. 8 illustrates another implementation of the action 306 that is shown in FIG. 3. As exemplified in FIG. 8, the process starts with identifying one or more calendars for the user (process action 800), and identifying one or more calendars for the selected service provider (process action 802). Each of the identified calendars for the user and each of the identified calendars for the selected service provider are then collectively analyzed to determine the aforementioned soonest co-available open time-slot (process action 804). The user is then asked to confirm (e.g., accept) the scheduling of the appointment for this soonest co-available open time-slot (process action 806). Upon receiving this confirmation from the user, the appointment is entered into this soonest co-available open time-slot in each of the identified calendars for the user, and the appointment is also entered into this soonest co-available open time-slot in each of the identified calendars for the selected service provider (process action 808).

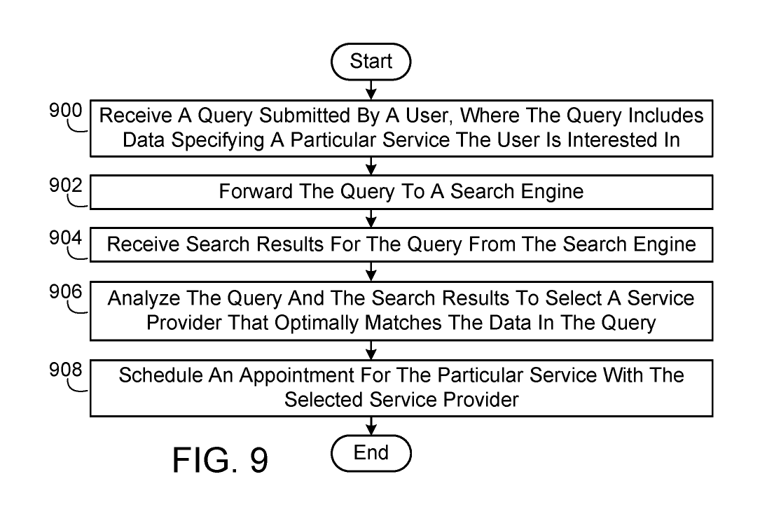

FIG. 9 illustrates another implementation, in simplified form, of a process for scheduling appointments. In an exemplary implementation of the appointment scheduling technique described herein the process illustrated in FIG. 9 is realized on the system framework 100 illustrated in FIG. 1. As exemplified in FIG. 9, the process starts with receiving a query that is submitted by a user, where the query includes data specifying a particular service the user is interested in (process action 900). As described heretofore, besides specifying the type of service the user is interested in, the data that the user enters into the query may specify one or more of a wide variety of attributes of this service. After the user's query has been received (action 900), the query is forwarded to a search engine (process action 902). Upon receiving search results for the query from the search engine (process action 904), the query and the search results are analyzed to select a service provider that optimally matches the data in the query (process action 906). An appointment for the service of interest is then scheduled with the selected service provider (process action 908).

The appointment scheduling technique implementations described herein are generally operable with any type of search engine query that specifies any type of service a user is interested in. For example, in an exemplary case where a given user is interested in scheduling an appointment with a spa, the user might submit a very simple query containing the data “spa”. The user might also submit a more descriptive query containing the data “waxing spa” to indicate that they are interested in a spa which provides a waxing service. The user might also submit an even more descriptive query containing the data “waxing spa redmond” to indicate that they are interested in a spa which provides a waxing service and is located in or near the city of Redmond. The user might also submit an even more descriptive query containing the data “waxing spa redmond 5 star” to indicate that they are interested in a spa which provides a waxing service, is located in or near the city of Redmond, and has a 5 star rating.

In another exemplary case where a given user is interested in scheduling an appointment with a dentist, the user might submit a very simple query containing the data “dentist”. The user might also submit a more descriptive query containing the data “female dentist” to indicate that they are interested in a dentist who is female. The user might also submit an even more descriptive query containing the data “female dentist 98052” to indicate that they are interested in a dentist who is female and is located in or near the 98052 zip code. The user might also submit an even more descriptive query containing the data “female dentist 98052 4 star” to indicate that they are interested in a dentist who is female, is located in or near the 98052 zip code, and has at least a 4 star rating.

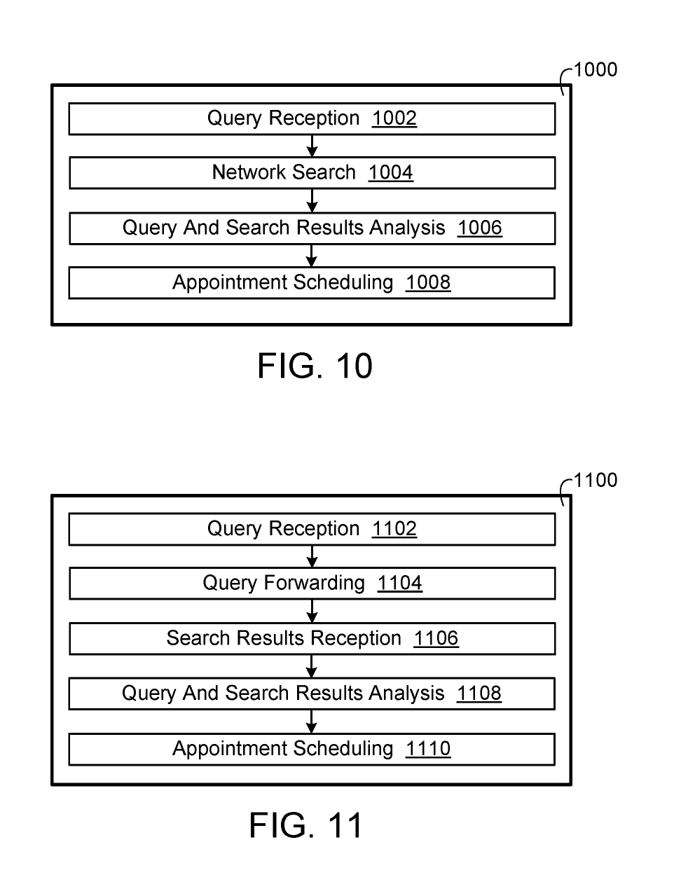

FIG. 10 illustrates one implementation, in simplified form, of an appointment scheduler computer program for scheduling appointments. As exemplified in FIG. 10 and referring again to FIG. 3, the appointment scheduler computer program 1000 includes, but is not limited to, a query reception sub-program 1002 that performs action 300, a network search sub-program 1004 that performs action 302, a query and search results analysis sub-program 1006 that performs action 304, and an appointment scheduling sub-program 1008 that performs action 306. Each of the just-described sub-programs is realized on a computing device such as that which is described in more detail in the Exemplary Operating Environments section which follows. More particularly and by way of example but not limitation, and referring again to FIG. 2, in one implementation of the appointment scheduling technique described herein the just-described sub-programs may be realized on the computing devices 218/220.

FIG. 11 illustrates another implementation, in simplified form, of an appointment scheduler computer program for scheduling appointments. As exemplified in FIG. 11 and referring again to FIG. 9, the appointment scheduler computer program 1100 includes, but is not limited to, a query reception sub-program 1102 that performs action 900, a query forwarding sub-program 1104 that performs action 902, a search results reception sub-program 1106 that performs action 904, a query and search results analysis sub-program 1108 that performs action 906, and an appointment scheduling sub-program 1110 that performs action 908. Each of the just-described sub-programs is realized on a computing device such as that which is described in more detail in the Exemplary Operating Environments section which follows. More particularly and by way of example but not limitation, and referring again to FIG. 1, in one implementation of the appointment scheduling technique described herein the just-described sub-programs may be realized on the computing devices 122/124.

### 2.0 Other Implementations

While the appointment scheduling technique has been described by specific reference to implementations thereof, it is understood that variations and modifications thereof can be made without departing from the true spirit and scope of the appointment scheduling technique. It is noted that any or all of the aforementioned implementations throughout the description may be used in any combination desired to form additional hybrid implementations. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of the appended claims.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

### 3.0 Exemplary Operating Environments

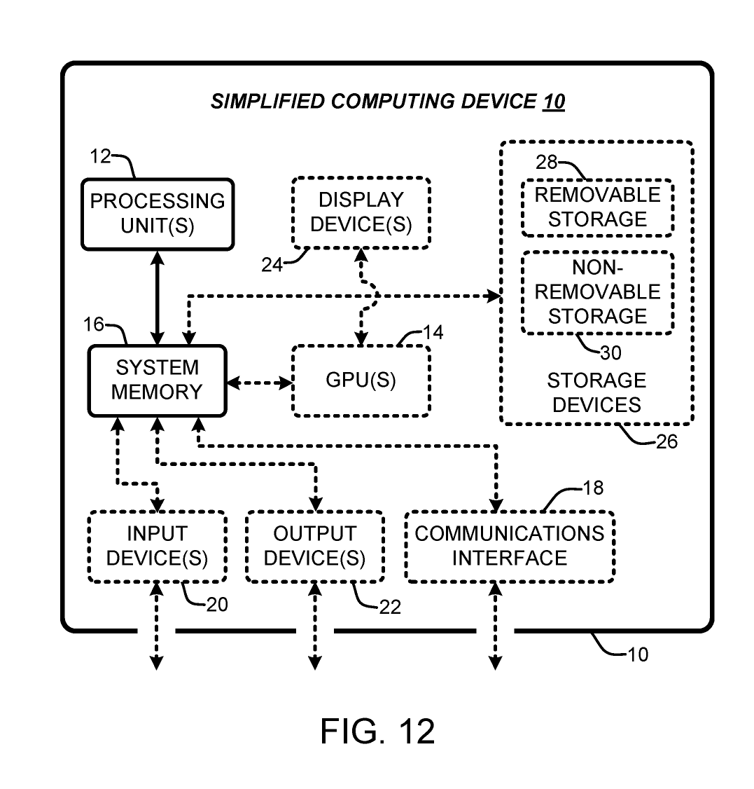

The appointment scheduling technique implementations described herein are operational within numerous types of general purpose or special purpose computing system environments or configurations. FIG. 12 illustrates a simplified example of a general-purpose computer system on which various implementations and elements of the appointment scheduling technique, as described herein, may be implemented. It is noted that any boxes that are represented by broken or dashed lines in the simplified computing device 10 shown in FIG. 12 represent alternate implementations of the simplified computing device. As described below, any or all of these alternate implementations may be used in combination with other alternate implementations that are described throughout this document. The simplified computing device 10 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the appointment scheduling technique implementations described herein, the device should have a sufficient computational capability and system memory to enable basic computational operations. In particular, the computational capability of the simplified computing device 10 shown in FIG. 12 is generally illustrated by one or more processing unit(s) 12, and may also include one or more graphics processing units (GPUs) 14, either or both in communication with system memory 16. Note that that the processing unit(s) 12 of the simplified computing device 10 may be specialized microprocessors (such as a digital signal processor (DSP), a very long instruction word (VLIW) processor, a field-programmable gate array (FPGA), or other micro-controller) or can be conventional central processing units (CPUs) having one or more processing cores.

In addition, the simplified computing device 10 may also include other components, such as, for example, a communications interface 18. The simplified computing device 10 may also include one or more conventional computer input devices 20 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 10 and with any other component or feature of the appointment scheduling technique implementations described herein, including input, output, control, feedback, and response to one or more users or other devices or systems associated with the appointment scheduling technique implementations, are enabled by a variety of Natural User Interface (NUI) scenarios. The NUI techniques and scenarios enabled by the appointment scheduling technique implementations include, but are not limited to, interface technologies that allow one or more users user to interact with the appointment scheduling technique implementations in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other sensors (e.g., speech and/or voice recognition). Such NUI implementations are also enabled by the use of various techniques including, but not limited to, information derived from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the appointment scheduling technique implementations described herein.

However, it should be understood that the aforementioned exemplary NUI scenarios may be further augmented by combining the use of artificial constraints or additional signals with any combination of NUI inputs. Such artificial constraints or additional signals may be imposed or generated by input devices such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the appointment scheduling technique implementations described herein.

The simplified computing device 10 may also include other optional components such as one or more conventional computer output devices 22 (e.g., display device(s) 24, audio output devices, video output devices, devices for transmitting wired or wireless data transmissions, and the like). Note that typical communications interfaces 18, input devices 20, output devices 22, and storage devices 26 for general-purpose computers are well known to those skilled in the art, and will not be described in detail herein.

The simplified computing device 10 shown in FIG. 12 may also include a variety of computer-readable media. Computer-readable media can be any available media that can be accessed by the computer 10 via storage devices 26, and can include both volatile and nonvolatile media that is either removable 28 and/or non-removable 30, for storage of information such as computer-readable or computer-executable instructions, data structures, programs, sub-programs, or other data. Computer-readable media includes computer storage media and communication media. Computer storage media refers to tangible computer-readable or machine-readable media or storage devices such as digital versatile disks (DVDs), blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, sub-programs, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, sub-programs, and/or computer program products embodying some or all of the various appointment scheduling technique implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The appointment scheduling technique implementations described herein may be further described in the general context of computer-executable instructions, such as programs, sub-programs, being executed by a computing device. Generally, sub-programs include routines, programs, objects, components, data structures, and the like, that perform particular tasks or implement particular abstract data types. The appointment scheduling technique implementations may also be practiced in distributed computing environments where tasks are performed by one or more remote processing devices, or within a cloud of one or more devices, that are linked through one or more communications networks. In a distributed computing environment, sub-programs may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include FPGAs, application-specific integrated circuits (ASICs), application-specific standard products (ASSPs), system-on-a-chip systems (SOCs), complex programmable logic devices (CPLDs), and so on.

### 4.0 Claim Support and Further Implementations

The following paragraphs summarize various examples of implementations which may be claimed in the present document. However, it should be understood that the implementations summarized below are not intended to limit the subject matter which may be claimed in view of the foregoing descriptions. Further, any or all of the implementations summarized below may be claimed in any desired combination with some or all of the implementations described throughout the foregoing description and any implementations illustrated in one or more of the figures, and any other implementations described below. In addition, it should be noted that the following implementations are intended to be understood in view of the foregoing description and figures described throughout this document.

In one implementation a first system is employed for scheduling appointments. This first system includes a first appointment scheduler that includes one or more computing devices, the computing devices being in communication with each other via a computer network whenever there is a plurality of computing devices. The first system also includes a computer program having a plurality of sub-programs executable by the computing devices, where the sub-programs configure the computing devices to, receive a query submitted by a user, the query comprising data specifying a particular service the user is interested in, search the computer network for information related to the data in the query, analyze the query and the information found in the search to select a service provider that optimally matches the data in the query, and schedule an appointment for the particular service with the selected service provider.

In one implementation of the just-described first system the sub-program for analyzing the query and the information found in the search to select a service provider that optimally matches the data in the query includes sub-programs for: parsing the data in the query to determine the particular service and any attributes thereof that are specified in the query; analyzing the information found in the search to identify a service provider that offers the particular service and optimally matches the attributes thereof; and assigning the identified service provider to be the selected service provider. In one version of the just-described implementation the information found in the search includes rating information for one or more service providers that offer the particular service, and the sub-program for analyzing the information found in the search to identify a service provider that offers the particular service and optimally matches the attributes thereof includes a sub-program for using this rating information as a factor in this analysis.

In another implementation the sub-program for analyzing the query and the information found in the search to select a service provider that optimally matches the data in the query includes sub-programs for: parsing the data in the query to determine the particular service and any attributes thereof that are specified in the query; receiving appointment metadata that includes appointment-related information associated with one or more of the user, or one or more service providers that offer the particular service the user is interested in; analyzing the information found in the search to identify a service provider that offers the particular service the user is interested in, and optimally matches the attributes thereof, this analysis also taking into consideration the appointment-related information found in the appointment metadata; and assigning the identified service provider to be the selected service provider. In one version of the just-described implementation the appointment metadata includes one or more of: appointment preferences for the user; or a last known geographic location of the user; or a physical address for a location where the user lives; or another physical address for another location where the user works; or work hours for the service providers that offer the particular service the user is interested in.

In another implementation the sub-program for scheduling an appointment for the particular service with the selected service provider includes sub-programs for: identifying one or more calendars for the user; identifying one or more calendars for the selected service provider; collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider; entering the appointment into this soonest open time-slot in each of the identified calendars for the user; and entering the appointment into this soonest open time-slot in each of the identified calendars for the selected service provider.

In one version of the just-described implementation the sub-program for collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider, includes sub-programs for: determining a prescribed number greater than one of the soonest open time-slots that are currently available for the appointment in each of the identified calendars for the user, and are also currently available for the appointment in each of the identified calendars for the selected service provider; sending a list of these soonest open time-slots to the user; receiving a one of the soonest open time-slots in this list that is selected by the user; and assigning the selected one of the soonest open time-slots to be the soonest open time-slot. In another version the sub-program for entering the appointment into this soonest open time-slot in each of the identified calendars for the user includes a sub-program for notifying the user that the appointment has been scheduled. In one variant of the just-described version the sub-program for notifying the user that the appointment has been scheduled includes a sub-program for sending the user a message specifying prescribed details about the appointment that has been scheduled, these prescribed details including a date and time for which the appointment has been scheduled. In one rendition of the just-described variant the prescribed details about the appointment that has been scheduled further include one or more of: the name of the selected service provider; or a physical address associated with the selected service provider; or a distance from this physical address to an expected geographic location of the user on the date for which, and a prescribed short period of time before which, the appointment has been scheduled; or contact information for the selected service provider; or a rating of the selected service provider generated by other users. In one adaptation of the just-described rendition this expected geographic location of the user is determined from the identified calendars for the user.

In another version of the just-described implementation the sub-program for entering the appointment into this soonest open time-slot in each of the identified calendars for the selected service provider includes a sub-program for notifying the selected service provider that the appointment has been scheduled. In one variant of the just-described version the sub-program for notifying the selected service provider that the appointment has been scheduled includes a sub-program for sending the selected service provider a message specifying prescribed details about the appointment that has been scheduled, these prescribed details including a date and time for which the appointment has been scheduled. In one rendition of the just-described variant the prescribed details about the appointment that has been scheduled further include one or more of: the name of the user; or a physical address associated with an expected geographic location of the user on the date and time for which the appointment has been scheduled; or a distance from this physical address to an expected geographic location of the selected service provider on the date for which, and a prescribed short period of time before which, the appointment has been scheduled; or contact information for the user. In one adaptation of the just-described rendition this expected geographic location of the selected service provider is determined from the identified calendars for the selected service provider.

In another implementation the sub-program for scheduling an appointment for the particular service with the selected service provider includes sub-programs for: identifying one or more calendars for the user; identifying one or more calendars for the selected service provider; collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider; asking the user to confirm the scheduling of the appointment for this soonest open time-slot; and upon receiving this confirmation from the user, entering the appointment into this soonest open time-slot in each of the identified calendars for the user, and entering the appointment into this soonest open time-slot in each of the identified calendars for the selected service provider.

The implementations, versions, variants, renditions and adaptations described in any of the previous paragraphs in this section may also be combined with each other, and with one or more of the implementations, versions, variants, renditions and adaptations described prior to this section. For example, some or all of the preceding implementations, versions, variants, renditions and adaptations may be combined with the foregoing implementation where the sub-program for scheduling an appointment for the particular service with the selected service provider includes sub-programs for: identifying one or more calendars for the user; identifying one or more calendars for the selected service provider; collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider; entering the appointment into this soonest open time-slot in each of the identified calendars for the user; and entering the appointment into this soonest open time-slot in each of the identified calendars for the selected service provider. In addition, some or all of the preceding implementations, versions, variants, renditions and adaptations may be combined with the foregoing implementation where the sub-program for scheduling an appointment for the particular service with the selected service provider includes sub-programs for: identifying one or more calendars for the user; identifying one or more calendars for the selected service provider; collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider; asking the user to confirm the scheduling of the appointment for this soonest open time-slot; and upon receiving this confirmation from the user, entering the appointment into this soonest open time-slot in each of the identified calendars for the user, and entering the appointment into this soonest open time-slot in each of the identified calendars for the selected service provider.

In another implementation a second system is employed for scheduling appointments. This second system includes a second appointment scheduler that includes one or more computing devices, the computing devices being in communication with each other via a computer network whenever there is a plurality of computing devices. The second system also includes a computer program having a plurality of sub-programs executable by the computing devices, where the sub-programs configure the computing devices to, receive a query submitted by a user, the query including data specifying a particular service the user is interested in, forward the query to a search engine, receive search results for the query from the search engine, analyze the query and the search results to select a service provider that optimally matches the data in the query, and schedule an appointment for the particular service with the selected service provider.

In one implementation of the just-described second system the sub-program for analyzing the query and the search results to select a service provider that optimally matches the data in the query includes sub-programs for: parsing the data in the query to determine the particular service and any attributes thereof that are specified in the query; analyzing the search results to identify a service provider that offers the particular service and optimally matches these attributes thereof; and assigning the identified service provider to be the selected service provider. In another implementation the sub-program for scheduling an appointment for the particular service with the selected service provider includes sub-programs for: identifying one or more calendars for the user; identifying one or more calendars for the selected service provider; collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider; entering the appointment into this soonest open time-slot in each of the identified calendars for the user; and entering the appointment into this soonest open time-slot in each of the identified calendars for the selected service provider.

In another implementation a computer-implemented process is employed for scheduling appointments. The process includes the actions of: using one or more computing devices to perform the following process actions, the computing devices being in communication with each other via a computer network whenever a plurality of computing devices is used: receiving a query submitted by a user, the query including data specifying a particular service the user is interested in; searching the computer network for information related to the data in the query; analyzing the query and the information found in this search to select a service provider that optimally matches the data in the query; and scheduling an appointment for this particular service with the selected service provider.

In another implementation a first appointment scheduling system is implemented by a first means for scheduling appointments. The first appointment scheduling system includes a first appointment scheduler that includes one or more computing devices. These computing devices are in communication with each other via a computer network whenever there is a plurality of computing devices. These computing devices include processors that are configured to execute: a first reception step for receiving a query submitted by a user, the query including data specifying a particular service the user is interested in; a searching step for searching the computer network for information related to the data in the query; a first analysis step for analyzing the query and the information found in the search to select a service provider that optimally matches the data in the query, and a first scheduling step for scheduling an appointment for the particular service with the selected service provider.

In one implementation of the just-described first appointment scheduling system the just-described first analysis step includes: a first parsing step for parsing the data in the query to determine the particular service and any attributes thereof that are specified in the query; a second analysis step for analyzing the information found in the search to identify a service provider that offers the particular service and optimally matches these attributes thereof; and a first assignment step for assigning the identified service provider to be the selected service provider. In one version of this implementation where the information found in the search includes rating information for one or more service providers that offer the particular service, the second analysis step includes a utilization step for using this rating information as a factor in this analysis.

In another implementation of the first appointment scheduling system the first analysis step includes: a second parsing step for parsing the data in the query to determine the particular service and any attributes thereof that are specified in the query; a second reception step for receiving appointment metadata that includes appointment-related information associated with one or more of the user, or one or more service providers that offer the particular service the user is interested in; a third analysis step for analyzing the information found in the search to identify a service provider that offers the particular service the user is interested in, and optimally matches these attributes thereof, this analysis also taking into consideration the appointment-related information found in the appointment metadata; and a second assignment step for assigning the identified service provider to be the selected service provider.

In another implementation of the first appointment scheduling system the aforementioned first scheduling step includes: an first identification step for identifying one or more calendars for the user; a second identification step for identifying one or more calendars for the selected service provider; a fourth analysis step for collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider; a first entry step for entering the appointment into this soonest open time-slot in each of the identified calendars for the user; and a second entry step for entering the appointment into this soonest open time-slot in each of the identified calendars for the selected service provider.

In one version of the just-described implementation the fourth analysis step includes: a determination step for determining a prescribed number greater than one of the soonest open time-slots that are currently available for the appointment in each of the identified calendars for the user, and are also currently available for the appointment in each of the identified calendars for the selected service provider; a first transmission step for sending a list of these soonest open time-slots to the user; a third reception step for receiving a one of the soonest open time-slots in this list that is selected by the user; and a third assignment step for assigning the selected one of the soonest open time-slots to be this soonest open time-slot. In another version of this implementation the just-described first entry step includes a first notification step for notifying the user that the appointment has been scheduled. In one variant of this version this first notification step includes a second transmission step for sending the user a message specifying prescribed details about the appointment that has been scheduled, these prescribed details including a date and time for which the appointment has been scheduled. In another version of this implementation the just-described second entry step includes a second notification step for notifying the selected service provider that the appointment has been scheduled. In one variant of this version this second notification step includes a third transmission step for sending the selected service provider a message specifying prescribed details about the appointment that has been scheduled, these prescribed details including a date and time for which the appointment has been scheduled.

In another implementation of the first appointment scheduling system the first scheduling step for scheduling an appointment for the particular service with the selected service provider includes: a third identification step for identifying one or more calendars for the user; a fourth identification step for identifying one or more calendars for the selected service provider; a fifth analysis step for collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider; a questioning step for asking the user to confirm the scheduling of the appointment for this soonest open time-slot; and upon receiving this confirmation from the user, a third entry step for entering the appointment into this soonest open time-slot in each of the identified calendars for the user, and a fourth entry step for entering the appointment into this soonest open time-slot in each of the identified calendars for the selected service provider.

In another implementation a second appointment scheduling system is implemented by a second means for scheduling appointments. The second appointment scheduling system includes a second appointment scheduler that includes one or more computing devices. These computing devices are in communication with each other via a computer network whenever there is a plurality of computing devices. These computing devices include processors that are configured to execute: a fourth reception step for receiving a query submitted by a user, the query including data specifying a particular service the user is interested in; a forwarding step for forwarding the query to a search engine; a fifth reception step for receiving search results for the query from the search engine; a sixth analysis step for analyzing the query and the search results to select a service provider that optimally matches the data in the query, and a second scheduling step for scheduling an appointment for the particular service with the selected service provider.

In one implementation of the just-described second appointment scheduling system the just-described sixth analysis step includes: a third parsing step for parsing the data in the query to determine the particular service and any attributes thereof that are specified in the query; a seventh analysis step for analyzing the search results to identify a service provider that offers the particular service and optimally matches these attributes thereof; and a fourth assignment step for assigning the identified service provider to be the selected service provider. In another implementation the just-described second scheduling step includes: a fifth identification step for identifying one or more calendars for the user; a sixth identification step for identifying one or more calendars for the selected service provider; an eighth analysis step for collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider; a fifth entry step for entering the appointment into this soonest open time-slot in each of the identified calendars for the user; and a sixth entry step for entering the appointment into this soonest open time-slot in each of the identified calendars for the selected service provider.

Wherefore, what is claimed is:

1. A system for scheduling appointments, comprising:
an appointment scheduler comprising one or more computing devices, said computing devices being in communication with each other via a computer network whenever there is a plurality of computing devices, and a computer program having a plurality of sub-programs executable by said computing devices, wherein the sub-programs configure said computing devices to,
receive a query submitted by a user, the query comprising data specifying a particular service the user is interested in,
search the computer network for information related to the data in the query,
analyze the query and the information found in said search to select a service provider that optimally matches the data in the query, and
schedule an appointment for said particular service with the selected service provider.

2. The system of claim 1, wherein the sub-program for analyzing the query and the information found in said search to select a service provider that optimally matches the data in the query comprises sub-programs for:
parsing the data in the query to determine said particular service and any attributes thereof that are specified in the query;
analyzing the information found in said search to identify a service provider that offers said particular service and optimally matches said attributes thereof; and
assigning the identified service provider to be the selected service provider.

3. The system of claim 2, wherein the information found in said search comprises rating information for one or more service providers that offer said particular service, and the sub-program for analyzing the information found in said search to identify a service provider that offers said particular service and optimally matches said attributes thereof comprises a sub-program for using said rating information as a factor in said analysis.

4. The system of claim 1, wherein the sub-program for analyzing the query and the information found in said search to select a service provider that optimally matches the data in the query comprises sub-programs for:
parsing the data in the query to determine said particular service and any attributes thereof that are specified in the query;
receiving appointment metadata comprising appointment-related information associated with one or more of the user, or one or more service providers that offer the particular service the user is interested in;
analyzing the information found in said search to identify a service provider that offers the particular service the user is interested in, and optimally matches said attributes thereof, said analysis also taking into consideration the appointment-related information found in the appointment metadata; and
assigning the identified service provider to be the selected service provider.

5. The system of claim 4, wherein the appointment metadata comprises one or more of:
appointment preferences for the user; or
a last known geographic location of the user; or
a physical address for a location where the user lives; or
another physical address for another location where the user works; or
work hours for the service providers that offer the particular service the user is interested in.

6. The system of claim 1, wherein the sub-program for scheduling an appointment for said particular service with the selected service provider comprises sub-programs for:
identifying one or more calendars for the user;
identifying one or more calendars for the selected service provider;
collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider;
entering the appointment into said soonest open time-slot in each of the identified calendars for the user; and
entering the appointment into said soonest open time-slot in each of the identified calendars for the selected service provider.

7. The system of claim 6, wherein the sub-program for collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider, comprises sub-programs for:
determining a prescribed number greater than one of the soonest open time-slots that are currently available for the appointment in each of the identified calendars for the user, and are also currently available for the appointment in each of the identified calendars for the selected service provider;
sending a list of said soonest open time-slots to the user;
receiving a one of the soonest open time-slots in said list that is selected by the user; and
assigning the selected one of the soonest open time-slots to be said soonest open time-slot.

8. The system of claim 6, wherein the sub-program for entering the appointment into said soonest open time-slot in each of the identified calendars for the user comprises a sub-program for notifying the user that the appointment has been scheduled.

9. The system of claim 8, wherein the sub-program for notifying the user that the appointment has been scheduled comprises a sub-program for sending the user a message specifying prescribed details about the appointment that has been scheduled, said prescribed details comprising a date and time for which the appointment has been scheduled.

10. The system of claim 9, wherein the prescribed details about the appointment that has been scheduled further comprise one or more of:
the name of the selected service provider; or
a physical address associated with the selected service provider; or
a distance from said physical address to an expected geographic location of the user on the date for which, and a prescribed short period of time before which, the appointment has been scheduled; or
contact information for the selected service provider; or
a rating of the selected service provider generated by other users.

11. The system of claim 10, wherein said expected geographic location of the user is determined from the identified calendars for the user.

12. The system of claim 6, wherein the sub-program for entering the appointment into said soonest open time-slot in each of the identified calendars for the selected service provider comprises a sub-program for notifying the selected service provider that the appointment has been scheduled.

13. The system of claim 12, wherein the sub-program for notifying the selected service provider that the appointment has been scheduled comprises a sub-program for sending the selected service provider a message specifying prescribed details about the appointment that has been scheduled, said prescribed details comprising a date and time for which the appointment has been scheduled.

14. The system of claim 13, wherein the prescribed details about the appointment that has been scheduled further comprise one or more of:
the name of the user; or
a physical address associated with an expected geographic location of the user on the date and time for which the appointment has been scheduled; or
a distance from said physical address to an expected geographic location of the selected service provider on the date for which, and a prescribed short period of time before which, the appointment has been scheduled; or
contact information for the user.

15. The system of claim 14, wherein said expected geographic location of the selected service provider is determined from the identified calendars for the selected service provider.

16. The system of claim 1, wherein the sub-program for scheduling an appointment for said particular service with the selected service provider comprises sub-programs for:
identifying one or more calendars for the user;
identifying one or more calendars for the selected service provider;
collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider;
asking the user to confirm the scheduling of the appointment for said soonest open time-slot; and
upon receiving said confirmation from the user,
entering the appointment into said soonest open time-slot in each of the identified calendars for the user, and
entering the appointment into said soonest open time-slot in each of the identified calendars for the selected service provider.

17. A system for scheduling appointments, comprising:
an appointment scheduler comprising one or more computing devices, said computing devices being in communication with each other via a computer network whenever there is a plurality of computing devices, and a computer program having a plurality of sub-programs executable by said computing devices, wherein the sub-programs configure said computing devices to,
receive a query submitted by a user, the query comprising data specifying a particular service the user is interested in,
forward the query to a search engine,
receive search results for the query from the search engine,
analyze the query and the search results to select a service provider that optimally matches the data in the query, and
schedule an appointment for said particular service with the selected service provider.

18. The system of claim 17, wherein the sub-program for analyzing the query and the search results to select a service provider that optimally matches the data in the query comprises sub-programs for:
parsing the data in the query to determine said particular service and any attributes thereof that are specified in the query;
analyzing the search results to identify a service provider that offers said particular service and optimally matches said attributes thereof; and
assigning the identified service provider to be the selected service provider.

19. The system of claim 17, wherein the sub-program for scheduling an appointment for said particular service with the selected service provider comprises sub-programs for:
identifying one or more calendars for the user;
identifying one or more calendars for the selected service provider;
collectively analyzing each of the identified calendars for the user and each of the identified calendars for the selected service provider to determine a soonest open time-slot that is currently available for the appointment in each of the identified calendars for the user, and is also currently available for the appointment in each of the identified calendars for the selected service provider;
entering the appointment into said soonest open time-slot in each of the identified calendars for the user; and
entering the appointment into said soonest open time-slot in each of the identified calendars for the selected service provider.

20. A computer-implemented process for scheduling appointments, the process comprising the actions of:
using one or more computing devices to perform the following process actions, the computing devices being in communication with each other via a computer network whenever a plurality of computing devices is used:
receiving a query submitted by a user, the query comprising data specifying a particular service the user is interested in;
searching the computer network for information related to the data in the query;
analyzing the query and the information found in said search to select a service provider that optimally matches the data in the query; and
scheduling an appointment for said particular service with the selected service provider.
